(19) United States
(12) Patent Application Publication
(10) Pub. No.: US 2006/0221914 A1
(43) Pub. Date: Oct. 5, 2006

(54) Passive scanning apparatus, system, and methods

(76) Inventor: Shai Waxman, Haifa (IL)

Correspondence Address: SCHWEGMAN, LUNDBERG, WOESSNER & KLUTH, P.A., P.O. BOX 2938, MINNEAPOLIS, MN, 55402, US

(21) Appl. No.: 11/095,935

(22) Filed: Mar. 31, 2005

(51) Int. Cl. H04Q 7/24

(52) U.S. Cl. 370/338

(57) ABSTRACT

Apparatus and systems, as well as methods and articles, may operate to maintain a wireless local area network (WLAN) association using a first receive chain in a multi-chain WLAN node, and to passively scan for one or more access point(s) while maintaining the association. The passive scan may be performed using a second receive chain collocated with the first receive chain in the WLAN node, wherein the second receive chain is unassigned to participate in the WLAN association.

### TECHNICAL FIELD

Various embodiments described herein relate to wireless communication technology generally, including apparatus, systems, and methods used to perform passive scans while associated with an access point.

### BACKGROUND INFORMATION

A wireless device operating according to an Institute of Electrical and Electronic Engineers 802.11 specification may authenticate itself to an access point and subsequently establish an “association” with the access point by registering as a node on the network. The wireless process of association may be analogous to inserting a network cable from a workstation into a network port (e.g., a port on a hub, switch, or router) in a wired environment. For additional information regarding IEEE 802.11 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments.

A wireless association may be more easily broken than a wired connection, however, since a continued association can depend upon radio frequency (RF) signal conditions. Thus, the wireless device may become dis-associated when RF noise levels, signal strengths, or other RF signal parameters change. Likewise, the changing RF signal conditions may cause one or more additional access point(s) (other than the access point currently associated with) to be detectable. Thus, a wireless device may evaluate signal strengths (or signal-to-noise ratios) within an operational band on an ongoing basis, and perhaps change the access point with which it is associated (“re-association”). This process, known in the art as “passive scanning,” may operate on beacon packets received from additional access points.

Passively scanning for additional access points may take considerable time, however, particularly for an active band comprising multiple channels. In the five gigahertz band, for example, passively scanning 30 channels may take three seconds or more, given a typical beacon interval of about 100 milliseconds. Since the wireless device may intersperse the passive scan operation with processing required to maintain the current association, a complete passive scan of the active band in the background may require a minute or more to complete. Thus, an active voice or data connection may time out and be dropped if the current association is broken by a degraded RF signal condition before the additional access point(s) are discovered.

### BRIEF DESCRIPTION OF THE DRAWINGS

FIG. 1 is a block diagram of apparatus and systems according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

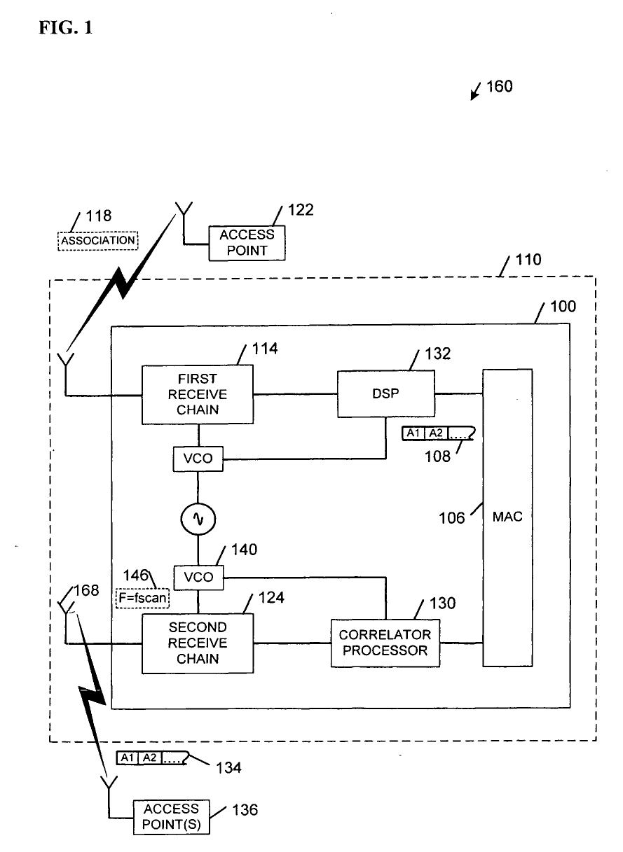

FIG. 1 comprises a block diagram of apparatus 100 and systems 160 according to various embodiments of the invention. The various embodiments may operate to decrease a period of time necessary to perform a background passive scan for additional access points while an association is maintained with a current access point. The apparatus 100 may include a media access control (MAC) module 106 to process packets 108 in a multi-chain wireless local area network (WLAN) node 110. The apparatus 100 may also include a first receive chain 114 in the WLAN node 110. The first receive chain 114 may be coupled to the MAC module 106 to maintain a WLAN association 118 involving the WLAN node 110, such as an association with a first access point 122.

The apparatus 100 may also include a second receive chain 124 coupled to the MAC module 106, collocated with the first receive chain 114. That is, the second receive chain 124 may be included in the WLAN node 110, and may be unassigned to participate in the WLAN association 118. It should be noted that a multiple-input, multiple-output (MIMO) device may have one or more receive chains unused when operating in a legacy mode according to an IEEE 802.11 specification, and one of the unused receive chains may comprise the second receive chain 124.

A correlator processor 130 may be coupled to the second receive chain 124. The correlator processor 130 may include processors, portions of processors, or operate using processing cycles derived from other processors. Thus, the correlator processor 130 may vary in processing power among different embodiments of the apparatus 100. The correlator processor 130 may, for example, comprise substantially a duplicate of a main digital signal processor (DSP) 132 used to maintain the WLAN association 118. Alternatively, the correlator processor 130 may comprise a less powerful beacon preamble correlator, perhaps comprising a limited-function device capable of recognizing and identifying a beacon packet 134 for the purpose of passive scanning.

The correlator processor 130 may passively scan for one or more second access point(s) 136 during a time when the first receive chain 114 maintains the WLAN association 118 with the first access point 122. The second access point(s) 136 may be non-participants in the WLAN association 118 involving the WLAN node 110. Some embodiments of the apparatus 100 may include a voltage-controlled oscillator (VCO) 140 coupled to the second receive chain 124 to control a receive chain passive scan frequency 146.

Other embodiments may be realized. For example, a system 160 may include one or more of the apparatus 100, including a media access control (MAC) module 106 to process packets in a 108 in a WLAN node 110, a first receive chain 114 to maintain a WLAN association 118 involving the WLAN node 110, a second receive chain 124, and a correlator processor 130, as previously described. The system 160 may also include an omnidirectional antenna 168 coupled to the second receive chain 124 to receive one or more beacon packet(s) 134 from one or more second access point(s) 136.

The MAC module 106 may be coupled to the correlator processor 130, and the correlator processor 130 may passively scan for the second access point(s) 136, wherein the second access point(s) 136 are non-participants in the WLAN association 118. The correlator processor 130 may be programmed to recognize the beacon packet(s) 134 received from the second access point(s) 136. The passive scan may be performed on all channels in a WLAN band to which the WLAN node 110 is configured, in less than about ten seconds.

Any of the components previously described can be implemented in a number of ways, including via software. Thus, the apparatus 100; media access control (MAC) module 106; packets 108, 134; wireless local area network (WLAN) node 110; receive chains 114, 124; WLAN association 118; access points 122, 136; correlator processor 130; digital signal processor (DSP) 132; voltage-controlled oscillator (VCO) 140; frequency 146; system 160; and antenna 168 may all be characterized as “modules” herein.

The modules may include hardware circuitry, single or multi-processor circuits, memory circuits, software program modules and objects, firmware, and combinations thereof, as desired by the architect of the apparatus 100 and system 160 and as appropriate for particular implementations of various embodiments. Thus, the modules may be included in a system operation simulation package such as a software electrical signal simulation package, a power usage and distribution simulation package, a capacitance-inductance simulation package, a power/heat dissipation simulation package, a signal transmission-reception simulation package, or any combination of software and hardware used to simulate the operation of various potential embodiments. These simulations may be used to design, characterize, or test the embodiments, for example.

It should also be understood that the apparatus and systems of various embodiments may be used in applications other than utilizing a standby receive chain and a correlator processor to decrease the time necessary to perform background passive scans for additional access points. Thus, various embodiments of the invention are not to be so limited. The illustrations of apparatus 100 and system 160 are intended to provide a general understanding of the structure of various embodiments, and are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments may include a number of methods.

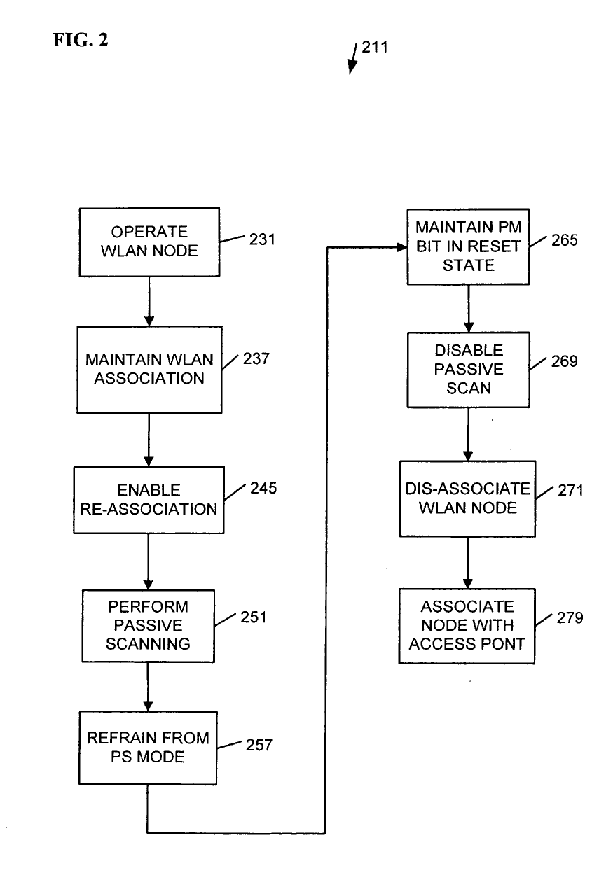

FIG. 2 is a flow diagram illustrating several methods 211 according to various embodiments of the invention. One such method 211 may begin at block 231 with operating a multi-chain WLAN node according to an IEEE 802.11 specification, and may continue at block 237 with maintaining a WLAN association using a first receive chain in the multi-chain WLAN node.

The method 211 may also include enabling re-association by the WLAN node without dropping a session such as a voice over internet protocol telephone conversation as the WLAN node moves at a rate of less than about five kilometers per hour, at block 245. This is about the speed at which a mobile phone user moves when walking about. This may be accomplished by passively scanning for one or more access point(s) other than an access point involved in the current WLAN association, during a time when the first receive chain maintains the WLAN association, at block 251.

The passive scan operation may utilize a second receive chain collocated with the first receive chain in the WLAN node, wherein the second receive chain is unassigned to participate in the WLAN association. The method 211 may continue with refraining from entering (e.g., holding off) a power-save mode while performing the passive scan, at block 257, and may include maintaining a power management bit in a media access control header transmitted by the WLAN node in a reset state, at block 265. The method 211 may also include selectively disabling the passive scan upon detecting about a minimum number of access points, at block 269.

The method 211 may continue with dis-associating the WLAN node from the WLAN association, at block 271, and may conclude with associating the WLAN node with one of the access point(s), at block 279.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembler or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized.

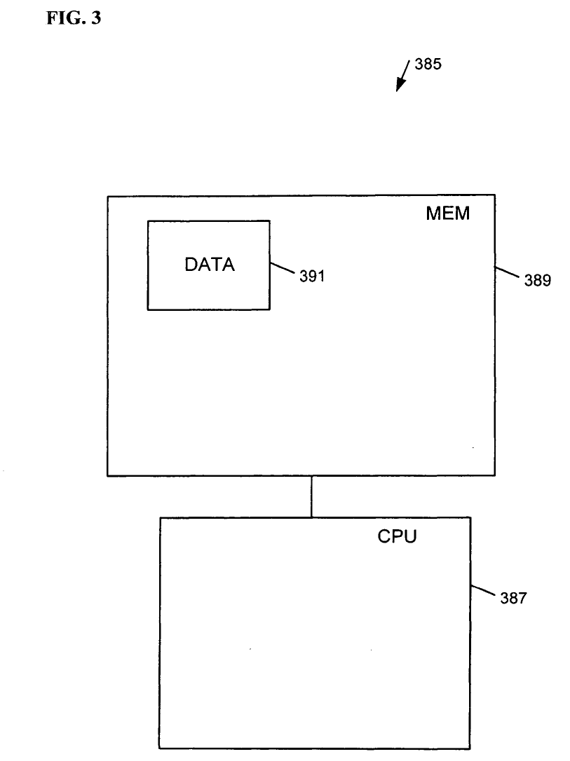

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) maintaining a wireless local area network (WLAN) association using a first receive chain in a multi-chain WLAN node.

Other activities may include passively scanning for at least one access point during a time when the first receive chain maintains the WLAN association using a second receive chain collocated with the first receive chain in the WLAN node, wherein the second receive chain is unassigned to participate in the WLAN association. Additional activities may include selectively disabling the passive scan upon detecting about a minimum number of access points, and enabling re-association by the WLAN node without dropping a voice over internet protocol telephone conversation as the WLAN node moves at a rate of less than about five kilometers per hour.

Implementing the apparatus, systems, and methods disclosed herein may operate to decrease the time used for additional access point passive scanning, utilizing a standby receive chain and a correlator processor to perform the passive scans.

Although the inventive concept may include embodiments described in the exemplary context of an 802.xx implementation (e.g., 802.11, 802.11a, 802.11g, 802.11n, 802.11 HT, 802.16, etc.), the claims are not so limited. Embodiments of the present invention may be implemented as part of any wired or wireless system Examples may also include embodiments comprising multi-carrier wireless communication channels (e.g., OFDM, DMT, etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a media access control (MAC) module to process packets in a multi-chain wireless local area network (WLAN) node;
a first receive chain in the WLAN node, coupled to the MAC module to maintain a WLAN association involving the WLAN node;
a second receive chain coupled to the MAC module, collocated with the first receive chain in the WLAN node and unassigned to participate in the WLAN association; and
a correlator processor coupled to the second receive chain to passively scan for at least one access point during a time when the first receive chain maintains the WLAN association.

2. The apparatus of claim 1, wherein the at least one access point is not a participant in the current WLAN association involving the WLAN node.

3. The apparatus of claim 1, further including:
a voltage-controlled oscillator coupled to the second receive chain to control a receive chain passive scan frequency.

4. The apparatus of claim 1, wherein the correlator processor comprises a digital signal processor.

5. The apparatus of claim 1, wherein the correlator processor comprises a beacon preamble correlator.

6. The apparatus of claim 1, wherein the WLAN association operates in a legacy mode, according to an Institute of Electrical and Electronic Engineers 802.11 specification.

7. A system, including:
a media access control (MAC) module to process packets in a multi-chain wireless local area network (WLAN) node;
a first receive chain in the WLAN node, coupled to the MAC module to maintain a WLAN association involving the WLAN node;
a second receive chain coupled to the MAC module, collocated with the first receive chain in the WLAN node and unassigned to participate in the WLAN association;
a correlator processor coupled to the second receive chain to passively scan for at least one access point during a time when the first receive chain maintains the WLAN association; and
an omnidirectional antenna coupled to the second receive chain to receive at least one beacon packet from the at least one access point.

8. The system of claim 7, wherein the at least one access point is not a participant in the WLAN association.

9. The system of claim 7, wherein the media access control (MAC) module is coupled to the correlator processor.

10. The system of claim 7, wherein the correlator processor is programmed to recognize beacon packets from the at least one access point.

11. The system of claim 7, wherein the passive scan is performed on all channels in a WLAN band to which the WLAN node is configured in less than about ten seconds.

12. A method, including:
maintaining a wireless local area network (WLAN) association using a first receive chain in a multi-chain WLAN node; and
passively scanning for at least one access point during a time when the first receive chain maintains the WLAN association, using a second receive chain collocated with the first receive chain in the WLAN node, wherein the second receive chain is unassigned to participate in the WLAN association.

13. The method of claim 12, wherein the at least one access point is not a participant in the WLAN association involving the WLAN node.

14. The method of claim 12, further including:
refraining from entering a power-save mode while performing the passive scan.

15. The method of claim 14, further including:
maintaining a power management bit in a media access control header transmitted by the WLAN node in a reset state.

16. The method of claim 12, further including:
dis-associating the WLAN node from the WLAN association.

17. The method of claim 12, further including:
associating the WLAN node with one of the at least one access points.

18. The method of claim 12, further including:
operating the WLAN node according to an Institute of Electrical and Electronic Engineers 802.11 specification.

19. An article including a machine-accessible medium having associated information, wherein the information, when accessed, results in a machine performing:
maintaining a wireless local area network (WLAN) association using a first receive chain in a multi-chain WLAN node; and
passively scanning for at least one access point during a time when the first receive chain maintains the WLAN association, using a second receive chain collocated with the first receive chain in the WLAN node, wherein the second receive chain is unassigned to participate in the WLAN association.

20. The article of claim 19, wherein the information, when accessed, results in a machine performing:
selectively disabling the passive scan upon detecting about a minimum number of access points.

21. The article of claim 19, wherein the information, when accessed, results in a machine performing:
enabling re-association by the WLAN node without dropping a voice over internet protocol telephone conversation as the WLAN node moves at a rate of less than about five kilometers per hour.
